(19) United States
(12) Patent Application Publication
(10) Pub. No.: US 2008/0205309 A1
(43) Pub. Date: Aug. 28, 2008

(54) VIRTUAL ADAPTATION LAYER FOR WIRELESS COMMUNICATION

(75) Inventor: Miika Laaksonen, Espoo (FI)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/538,704

(22) Filed: Oct. 4, 2006

(51) Int. Cl. H04L 12/56; H04B 7/00

(52) U.S. Cl. 370/310; 370/395.31

(57) ABSTRACT

A system for improving communication efficiency in a communication medium. In at least one embodiment of the present invention, communication efficiency in a wireless communication medium may be improved by routing communication packets to destination layers in a wireless protocol stack using a minimal amount of information. Communication packets may be routed by maintaining a set of virtual packet identification indicators for identifying and routing information to an appropriate communication layer, receiving information including a virtual packet identification; and resolving an information type and a communication protocol layer to which the received data should be routed by mapping the virtual packet identification included in the received information with the virtual packet identification indicators.

### BACKGROUND OF INVENTION

1. Field of Invention

The present invention relates to a system for routing communication packets in a wireless communication protocol, and more specifically, to routing communication packets to layers of a communication protocol stack without experiencing any expansion in size of the packet due to the addition of new header information for each subsequent protocol stack layer.

2. Description of Prior Art

More and more, the ability to communicate wirelessly is emerging as a popular feature to include in many devices where communication was previously not contemplated. This popularity may, at least in part, be fueled by rapid technological development in the area of multifunction wireless communication devices (WCD). Consumers may now replace common standalone productivity devices like computers, laptops, facsimile machines, personal digital assistants, etc. with a single device capable of performing all of these functions. Devices with these abilities have been embraced by business people who often find that work can now be completed during time that was previously wasted (commutes to and from work, home, etc.)

However, while a WCD may be empowered with many beneficial features, the small size and power constraints of these devices may also create a hindrance for the user. The operator interfaces installed in these devices are often small, and not conducive to high throughput. As a result, users must rely on peripheral input devices such as keyboards, mice, headsets, etc. in order to perform their work. Further, the small size of many devices today also implies that there is a lack of physical connections to connect wired devices. Therefore, a WCD must not only be able to support wireless communications with a peripheral device, it must also be able to support connections with multiple peripheral devices being operated concurrently.

As more and more common devices include electronic control, there may also be a benefit in coupling these devices to a WCD, or possibly other “intelligent” mechanisms. For example, it may be desirable to wirelessly link two or more low power devices in a beneficial relationship, such as linking a wristwatch including health-monitoring intelligence to various wireless sensors placed on a user's body. Simpler communication protocols with lower power requirements are now being developed so that even devices that have not historically been “computerized” may now provide wireless information to, and in some cases receive wireless information from, a WCD. These devices must often run on battery power, and as a result, must rely on simple, power efficient communications in order to be functional. Most of the existing wireless communication protocols are either too simple or too complex to make these newly computerized applications workable. For example, radio frequency (RF) communication is efficient and may be powered by a scanning device, however, currently available RF transponder chips are space-limited and usually only provide information. On the other hand, IEEE 802.11×WLAN or “WiFi” is a commonly available and widely accepted wireless solution. However, the power requirements for WLAN may not make it appropriate for small device installations. Bluetooth™ is another short-range wireless protocol that is often used for linking peripheral devices to a WCD. The Bluetooth™ standard was originally designed to replace wires with a wireless medium for simple peripheral input devices. While, Bluetooth™ has now evolved much further than linking headsets and mice, it still may not be the best solution for extremely resource constrained wireless devices, as will be explored further below.

What is therefore needed is a method for conveying information in a wireless communication medium in both a simple and efficient manner. The power requirements of the wireless medium should be kept low by having information transferred with the least amount of overhead. The minimization of overhead, however, should not affect the performance of the medium. Conveying less information in an inefficient manner may still result in wasted power.

### SUMMARY OF INVENTION

The present invention includes at least a method, computer program, device and data structure for improving communication efficiency in a communication medium. In at least one embodiment of the present invention, communication efficiency in a wireless communication medium may be improved by routing communication packets to destination layers in a wireless protocol stack using a minimal amount of information. Communication packets may be routed by maintaining a set of virtual packet identification indicators for identifying and routing information to an appropriate communication layer, receiving information including a virtual packet identification; and resolving an information type and a communication protocol layer to which the received data should be routed by mapping the virtual packet identification included in the received information with the virtual packet identification indicators.

In the example of the present invention as recited above, a communication identifier for each packet may identify both a type of information included in packet and the destination of the packet. The type of information may include, for instance, a command used for establishing or maintaining a wireless connection, or data related to an application or peripheral device that may utilize the wireless communication medium. The type of data included in the packet may determine to which layer the data should be routed. This information may be compared to a mapping in a wireless communication device, and depending on a numeric range that the identification data falls within, the information may be routed to a particular communication layer.

As a result of the system of the present invention, additional header data may not be required as a communication packet traverses from one layer to another. A benefit may then be seen because the size of the packet will not expand, and the power needed to convey the packet may remain low, improving the overall efficiency of the communication medium.

### DESCRIPTION OF DRAWINGS

The invention will be further understood from the following detailed description of a preferred embodiment, taken in conjunction with appended drawings, in which:

FIG. 1A discloses a modular description of an exemplary wireless communication device usable with at least one embodiment of the present invention.

FIG. 1B discloses an exemplary structural description of the wireless communication device previously described in FIG. 1A.

FIG. 2 discloses an exemplary Bluetooth™ protocol stack and an exemplary Wibree™ protocol stack usable with at least one embodiment of the present invention.

FIG. 3A discloses an example of multiple wireless peripheral devices attempting to communicate concurrently with a dual-mode radio modem in accordance with at least one embodiment of the present invention.

FIG. 3B discloses further detail pertaining to the example of FIG. 3A regarding operational enhancements for managing the operation of a dual-mode modem in accordance with at least one embodiment of the present invention.

FIG. 4 discloses a more detailed example of a Wibree™ protocol stack in accordance with at least one embodiment of the present invention.

FIG. 5A discloses an example of communication packet growth as a part of routing in a typical communication protocol.

FIG. 5B discloses exemplary tables used for mapping identification numbers in accordance with at least one embodiment of the present invention.

FIG. 6A discloses an example of the routing of communication packets to various layers in a communication protocol in accordance with at least one embodiment of the present invention.

FIG. 6B discloses specific examples of communication packets that may be routed to a profile layer in a communication protocol in accordance with at least one embodiment of the present invention.

FIG. 7A discloses an example of identifying a control command that may be contained in a communication packet in accordance with at least one embodiment of the present invention.

FIG. 7B discloses specific examples of communication packet identification in accordance with at least one embodiment of the present invention.

FIG. 8 discloses a flowchart of an exemplary process for identifying a communication packet destination and/or type based on mapping an ID code in accordance with at least one embodiment of the present invention.

### DESCRIPTION OF PREFERRED EMBODIMENT

While the invention has been described in preferred embodiments, various changes can be made therein without departing from the spirit and scope of the invention, as described in the appended claims.

### I. Wireless Communication Device

As previously described, the present invention may be implemented using a variety of wireless communication equipment. Therefore, it is important to understand the communication tools available to a user before exploring the present invention. For example, in the case of a cellular telephone or other handheld wireless devices, the integrated data handling capabilities of the device play an important role in facilitating transactions between the transmitting and receiving devices.

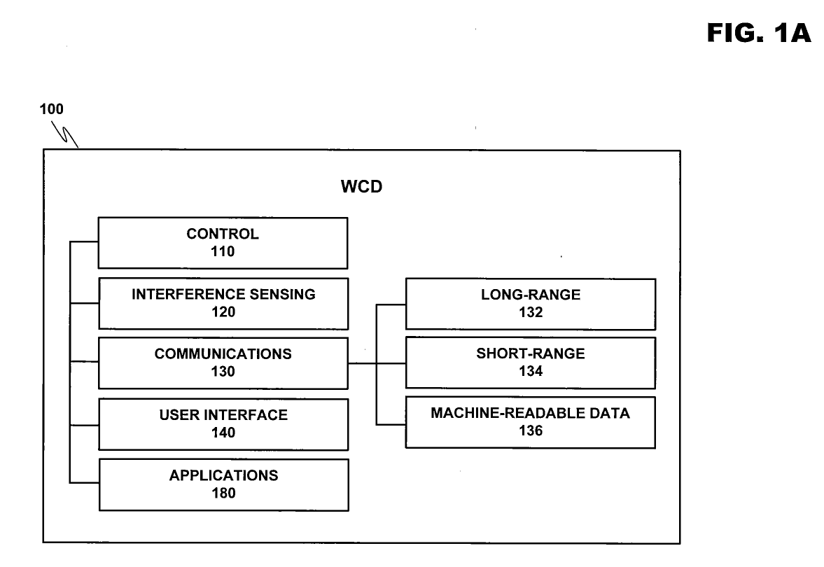

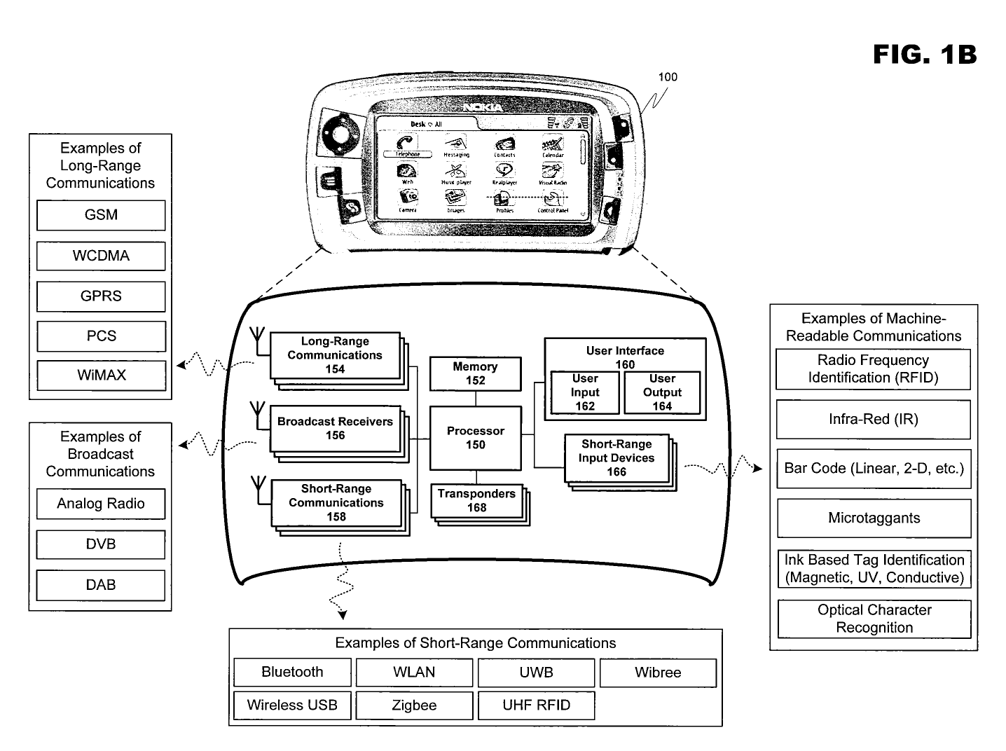

FIG. 1A discloses an exemplary modular layout for a wireless communication device usable with the present invention. WCD 100 is broken down into modules representing the functional aspects of the device. These functions may be performed by the various combinations of software and/or hardware components discussed below.

Control module 110 regulates the operation of the device. Inputs may be received from various other modules included within WCD 100. For example, interference sensing module 120 may use various techniques known in the art to sense sources of environmental interference within the effective transmission range of the wireless communication device. Control module 110 interprets these data inputs, and in response, may issue control commands to the other modules in WCD 100.

Communications module 130 incorporates all of the communication aspects of WCD 100. As shown in FIG. 1A, communications module 130 may include, for example, long-range communications module 132, short-range communications module 134 and machine-readable data module 136 (e.g., for NFC). Communications module 130 utilizes at least these sub-modules to receive a multitude of different types of communication from both local and long distance sources, and to transmit data to recipient devices within the transmission range of WCD 100. Communications module 130 may be triggered by control module 110, or by control resources local to the module responding to sensed messages, environmental influences and/or other devices in proximity to WCD 100.

User interface module 140 includes visual, audible and tactile elements which allow a user to receive data from, and enter data into, the device. The data entered by a user may be interpreted by control module 110 to affect the behavior of WCD 100. User-inputted data may also be transmitted by communications module 130 to other devices within effective transmission range. Other devices in transmission range may also send information to WCD 100 via communications module 130, and control module 110 may cause this information to be transferred to user interface module 140 for presentment to the user.

Applications module 180 incorporates all other hardware and/or software applications on WCD 100. These applications may include sensors, interfaces, utilities, interpreters, data applications, etc., and may be invoked by control module 210 to read information provided by the various modules and in turn supply information to requesting modules in WCD 100.

FIG. 1B discloses an exemplary structural layout of WCD 100 according to an embodiment of the present invention that may be used to implement the functionality of the modular system previously described in FIG. 1A. Processor 150 controls overall device operation. As shown in FIG. 1B, processor 150 is coupled to at least communications sections 154, 158 and 166. Processor 150 may be implemented with one or more microprocessors that are each capable of executing software instructions stored in memory 152.

Memory 152 may include random access memory (RAM), read only memory (ROM), and/or flash memory, and stores information in the form of data and software components (also referred to herein as modules). The data stored by memory 152 may be associated with particular software components. In addition, this data may be associated with databases, such as a bookmark database or a business database for scheduling, email, etc.

The software components stored by memory 152 include instructions that can be executed by processor 150. Various types of software components may be stored in memory 152. For instance, memory 152 may store software components that control the operation of communication sections 154, 158 and 166. Memory 152 may also store software components including a firewall, a service guide manager, a bookmark database, user interface manager, and any communication utilities modules required to support WCD 100.

Long-range communications 154 performs functions related to the exchange of information over large geographic areas (such as cellular networks) via an antenna. These communication methods include technologies from the previously described 1G to 3G. In addition to basic voice communication (e.g., via GSM), long-range communications 154 may operate to establish data communication sessions, such as General Packet Radio Service (GPRS) sessions and/or Universal Mobile Telecommunications System (UMTS) sessions. Also, long-range communications 154 may operate to transmit and receive messages, such as short messaging service (SMS) messages and/or multimedia messaging service (MMS) messages.

As a subset of long-range communications 154, or alternatively operating as an independent module separately connected to processor 150, transmission receiver 156 allows WCD 100 to receive transmission messages via mediums such as Digital Video Broadcast for Handheld Devices (DVB-H). These transmissions may be encoded so that only certain designated receiving devices may access the transmission content, and may contain text, audio or video information. In at least one example, WCD 100 may receive these transmissions and use information contained within the transmission signal to determine if the device is permitted to view the received content.

Short-range communications 158 is responsible for functions involving the exchange of information across short-range wireless networks. As described above and depicted in FIG. 1B, examples of such short-range communications 158 are not limited to Bluetooth™, Wibree™, WLAN, UWB and Wireless USB connections. Accordingly, short-range communications 158 performs functions related to the establishment of short-range connections, as well as processing related to the transmission and reception of information via such connections.

Short-range input device 166, also depicted in FIG. 1B, may provide functionality related to the short-range scanning of machine-readable data (e.g., for NFC). For example, processor 150 may control short-range input device 166 to generate RF signals for activating an RFID transponder, and may in turn control the reception of signals from an RFID transponder. Other short-range scanning methods for reading machine-readable data that may be supported by short-range input device 166 are not limited to IR communication, linear and 2-D (e.g., QR) bar code readers (including processes related to interpreting UPC labels), and optical character recognition devices for reading magnetic, UV, conductive or other types of coded data that may be provided in a tag using suitable ink. In order for short-range input device 166 to scan the aforementioned types of machine-readable data, the input device may include optical detectors, magnetic detectors, CCDs or other sensors known in the art for interpreting machine-readable information.

As further shown in FIG. 1B, user interface 160 is also coupled to processor 150. User interface 160 facilitates the exchange of information with a user. FIG. 1B shows that user interface 160 includes a user input 162 and a user output 164. User input 162 may include one or more components that allow a user to input information. Examples of such components include keypads, touch screens, and microphones. User output 164 allows a user to receive information from the device. Thus, user output portion 164 may include various components, such as a display, light emitting diodes (LED), tactile emitters and one or more audio speakers. Exemplary displays include liquid crystal displays (LCDs), and other video displays.

WCD 100 may also include one or more transponders 168. This is essentially a passive device that may be programmed by processor 150 with information to be delivered in response to a scan from an outside source. For example, an RFID reader mounted in an entryway may continuously emit radio frequency waves. When a person with a device containing transponder 168 walks through the door, the transponder is energized and may respond with information identifying the device, the person, etc. In addition, a reader may be mounted (e.g., as discussed above with regard to examples of short-range input device 166) in WCD 100 so that it can read information from other transponders in the vicinity.

Hardware corresponding to communications sections 154, 156, 158 and 166 provide for the transmission and reception of signals. Accordingly, these portions may include components (e.g., electronics) that perform functions, such as modulation, demodulation, amplification, and filtering. These portions may be locally controlled, or controlled by processor 150 in accordance with software communication components stored in memory 152.

The elements shown in FIG. 1B may be constituted and coupled according to various techniques in order to produce the functionality described in FIG. 1A. One such technique involves coupling separate hardware components corresponding to processor 150, communications sections 154, 156 and 158, memory 152, short-range input device 166, user interface 160, transponder 168, etc. through one or more bus interfaces (which may be wired or wireless bus interfaces). Alternatively, any and/or all of the individual components may be replaced by an integrated circuit in the form of a programmable logic device, gate array, ASIC, multi-chip module, etc. programmed to replicate the functions of the stand-alone devices. In addition, each of these components is coupled to a power source, such as a removable and/or rechargeable battery (not shown).

The user interface 160 may interact with a communication utilities software component, also contained in memory 152, which provides for the establishment of service sessions using long-range communications 154 and/or short-range communications 158. The communication utilities component may include various routines that allow the reception of services from remote devices according to mediums such as the Wireless Application Medium (WAP), Hypertext Markup Language (HTML) variants like Compact HTML (CHTML), etc.

### II. Wireless Communication Mediums

The present invention may be implemented with, but is not limited to, short-range wireless communication mediums. Bluetooth™ is an example of a short-range wireless technology quickly gaining acceptance in the marketplace. A Bluetooth™ enabled WCD may transmit and receives data, for example, at a rate of 720 Kbps within a range of 10 meters, and may transmit up to 100 meters with additional power boosting. Current systems may run at a nominal rate of 1 Mbps. A user does not actively instigate a Bluetooth™ network. Instead, a plurality of devices within operating range of each other will automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master, and wait for an active slot to become available. These devices continually switch between various active communication and power saving modes in order to transmit data to other piconet members. In addition to Bluetooth™ other popular short-range wireless networks include WLAN (of which “Wi-Fi” local access points communicating in accordance with the IEEE 802.11 standard, is an example), WUSB, UWB, ZigBee (802.15.4, 802.15.4a), Wibree™ and UHF RFID. All of these wireless mediums have features and advantages that make them appropriate for various applications.

Wibree™ is an open standard industry initiative extending local connectivity to small devices with technology that increases the growth potential in these market segments. Wibree™ technology may complement close range communication with Bluetooth™-like performance in the 0-10 m range with a data rate of 1 Mbps. Wibree™ is optimized for applications requiring extremely low power consumption, small size and low cost. Wibree™ may be implemented either as stand-alone chip or as Bluetooth™-Wibree™ dual-mode chip. More information can be found on the Wibree™ website: www.wibree.com.

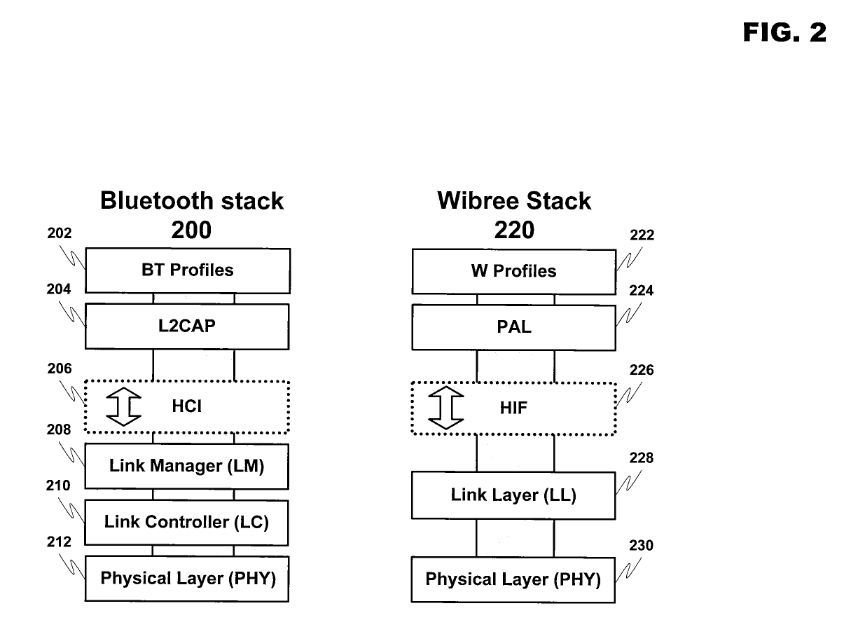

Now referring to FIG. 2, an exemplary Bluetooth™ protocol stack and an exemplary Wibree™ protocol stack are disclosed. Bluetooth™ stack 200 includes elements that may convey information from a system level to a physical layer where it may be transmitted wireless to another device. At the top level, BT Profiles 202 include at least a description of a known peripheral device which may be connected wirelessly to WCD 100, or an application that may utilize Bluetooth™ in order to engage in wireless communication with a peripheral device. The use of the phrase “peripheral devices” is not intended to limit the present invention, and is used only to represent any device external to WCD 100 also capable of wirelessly communicating with WCD 100. Bluetooth™ profiles of other devices may be established through a pairing procedure wherein identification and connection information for a peripheral device may be received by WCD 100 through a polling process and then saved in order to expedite the connection to the device at a later time. After the application and/or target peripheral device (or devices) is established, any information to be sent must be prepared for transmission. L2CAP level 204 includes at least a logical link controller and adaptation protocol. This protocol supports higher level protocol multiplexing packet segmentation and reassembly, and the conveying of quality of service information. The information prepared by L2CAP level 204 may then be passed to an application-optional host controller interface (HCI) 206. This layer may provide a command interface to the lower link manager protocol (LMP) layers, link manager (LM) 208 and link controller (LC) 210. LM 208 may establish the link setup, authentication, link configuration and other protocols related to establishing a wireless link between two or more devices. Further, LC 210 may manage active links between two or more devices by handling low-level baseband protocols. Wireless communication may then be established and conducted using the hardware (modem, antenna, etc.) making up physical layer (PHY) 212. Of course, the above identified layers of Bluetooth™ stack 200 may also be utilized in an order reversed from that disclosed above in order to receive a wireless transmission into WCD 100 from a peripheral device.

The layers in the standalone Wibree™ stack 220 are similar to the elements previously described. However, due to the relative simplicity of Wibree™ when compared to Bluetooth™, there are actually less layers utilized to achieve wireless communication. W Profiles 222, similar to the profiles used in Bluetooth™, are used to specify applications that may use Wibree™ for communication and peripheral devices with which a Wibree™ modem may wirelessly communicate. The profile adoption layer (PAL) 224 may be used to prepare the information for transmission via wireless communication. Host interface (HIF) layer 226 may provide an interface between the upper layers communicating with applications and schedulers in WCD 100, and the lower layers of the Wibree™ stack 220 which establish and maintain the links to peripheral devices. Lower layers of the Wibree™ stack 220 may further include at least link layer (LL) 228. LL 228 may both establish and maintain wireless communications with other wireless enabled devices through the use of Physical Layer (PHY) 230. Wibree™ LL 228, however, differs significantly from LM 208 and LC 210 in Bluetooth™.

### III. Dual-Mode Modem

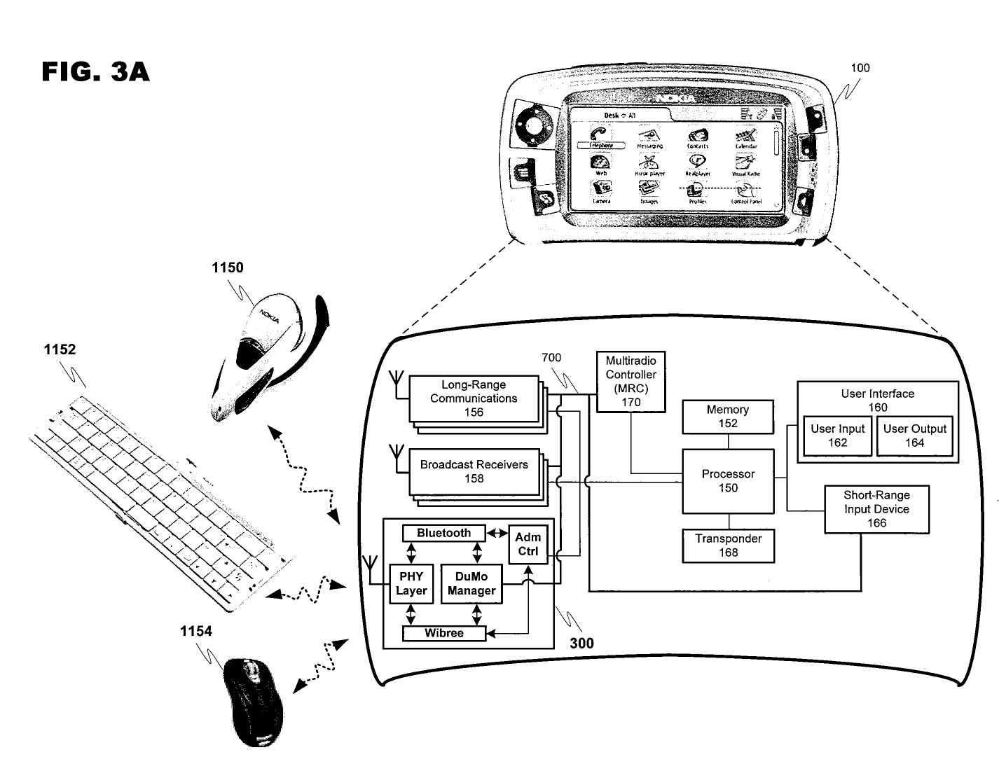

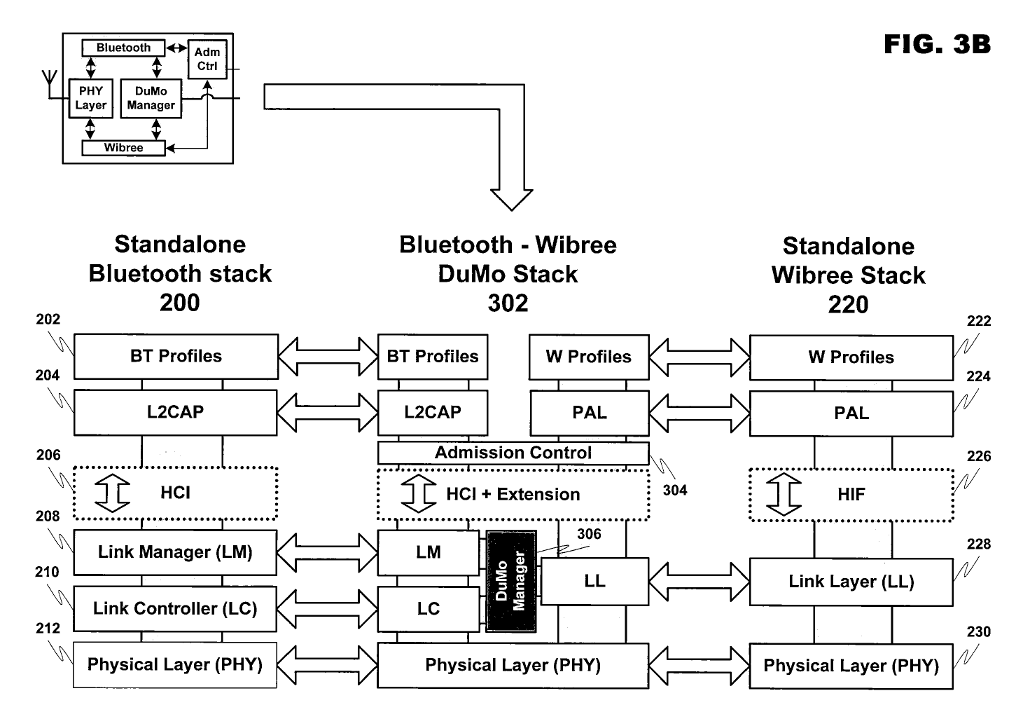

FIG. 3A includes an alternative exemplary implementation of at least one embodiment of the present invention. Again, in this example the three peripheral devices (1150, 1152 and 1154) are attempting concurrent communication with WCD 100 through dual-mode radio modem 300. Radio modem 300 may include local control resources for managing both “radios” (e.g., Bluetooth™ and Wibree™ software based radio control stacks) attempting to use the physical layer (PHY) resources of dual-mode radio modem 300. In this example, dual-mode radio modem 300 includes at least two radio stacks or radio protocols (labeled “Bluetooth” and “Wibree”) that may share the PHY layer resources (e.g., hardware resources, antenna, etc.) of dual-mode radio modem 300. The local control resources may include an admission controller (“Adm Ctrl”) and a dual-mode controller (“DuMo Manager”). These local control resources may be embodied as a software program and/or in a hardware form (e.g., logic device, gate array, MCM, ASIC, etc.) in a dual-mode radio modem interface, and the radio modem interface may be coupled to, or alternatively, embedded in dual-mode radio modem 300. The interaction of these control resources with the radio protocols utilizing dual-mode radio modem 300 is explained below.

With respect to FIG. 3B, an exemplary combination of the two separate radio protocol stacks (previously discussed with respect to FIG. 2) into a single combined entity controlled locally by at least an admission control 304 and a DuMo manager 306 is now disclosed. The two previously described standalone stacks are shown to establish the individual elements that may be incorporated into an integrated dual-mode entity 302. For a more specific discussion of the functioning of admission control 304 and a DuMo manager 306 in terms of managing the operations of dual-mode modem 300, please refer to application Ser. No. 11/538,310, filed Oct. 3, 2006, which is hereby incorporated by reference. Briefly, Admission control 304 may act as a gateway for the dual-mode radio modem 300 by filtering out both Bluetooth™ and Wibree™ requests from the operating system of WCD 100 that may result in conflicts. Scheduling information may also be provided by Multiradio controller (MRC) 170, wherein certain periods of operation are allocated to dual-mode radio modem 300 in view of the other active radio modems operating in WCD 100. This scheduling information may be passed down to both the HCI+Extension level of the combined protocol stacks and also to DuMo manager 1228 for further processing. However, if scheduling information from MRC 600 is critical (delay-sensitive), it may be sent through MCS 700 via a direct connection to DuMo Manager 1228. The information received by DuMo manager may 306 then be used to create an interleaved schedule for dual-mode radio modem 300 allowing both the Bluetooth™ and Wibree™ protocols to operate concurrently.

### IV. Protocol Stacks and Packet Routing

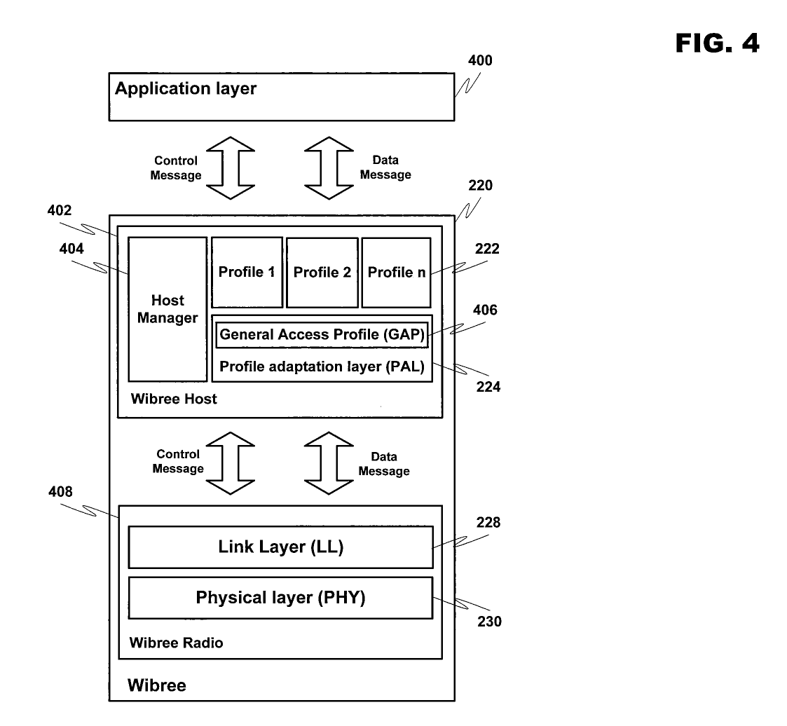

FIG. 4 includes a more detailed description of the upper layers of the Wibree™ communication protocol. The Wibree™ system includes two parts: the Wibree™ Radio 408 and the Wibree™ Host 402. Connection between radio 408 and host 402 goes through the HIF (Host Interface). Further, PAL 224 includes at least General Access Profile (GAP) 406.

Application layer 400 may include various programs that may be executed on a computing device. For example, an application may be a communication utility or productivity program running on a WCD. An application may use W Profiles 222 in Wibree™ (e.g. Profile 1, Profile 2, etc.) in order to send information into the Wibree™ protocol stack 220. This transaction may be supervised by Host Manager 404. The information may then be prepared by PAL 224 and GAP 406 for routing to Wibree™ radio 408, wherein LL 228 may both establish new wireless connections and manage existing connections with peripheral devices through the various resources (modem, antenna, etc.) that make up PHY layer 230.

V. Problems with Packet Routing in Existing Devices

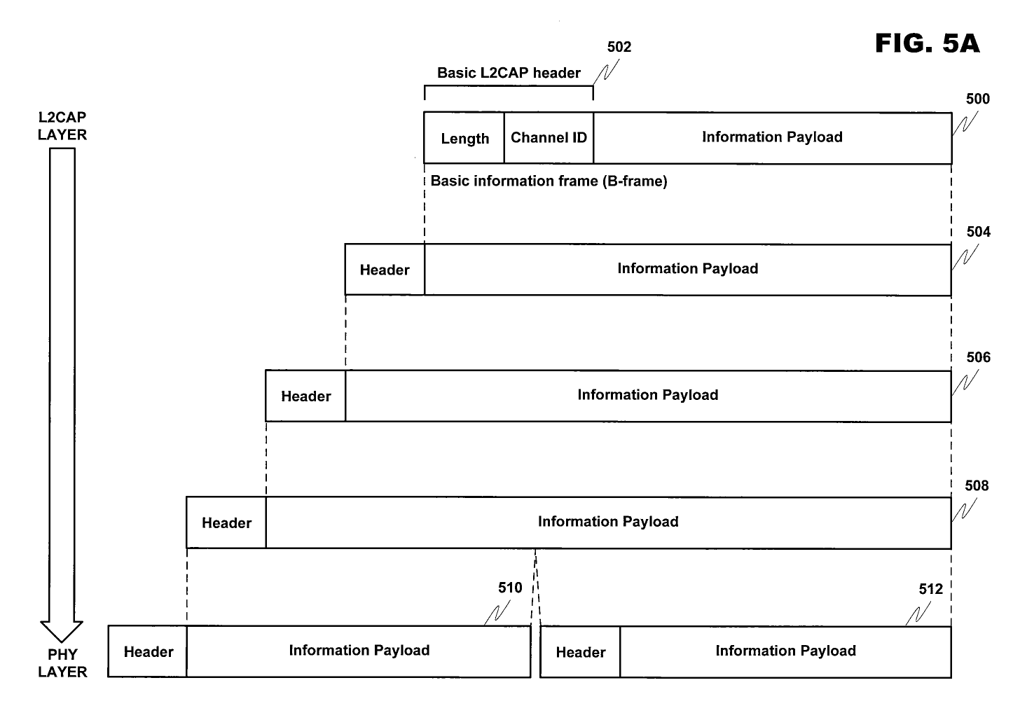

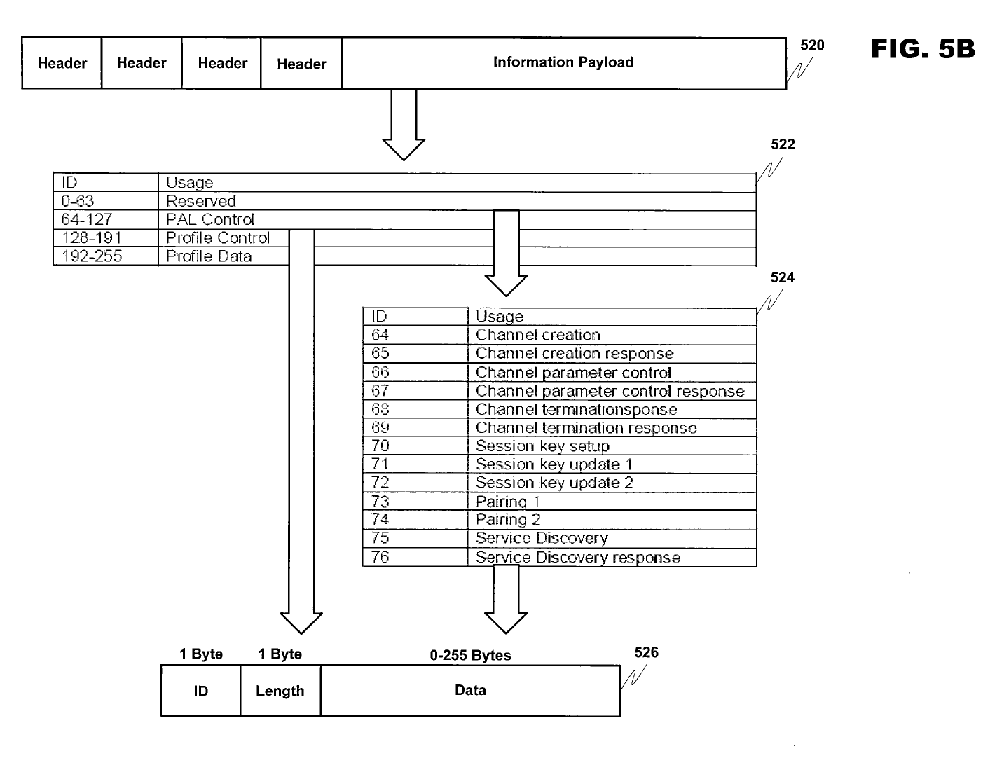

FIG. 5A discloses an exemplary packet routing in a communication protocol stack in accordance with methods currently known in the art. The wireless communication protocol in this example is Bluetooth™. A basic information frame packet (B-frame packet) is disclosed at 500. Packet 500 may include at least a header portion and a payload portion. The header portion of the packet contains routing destination information for the packet, and the payload includes information such as general data, commands with corresponding parameters, etc. The header information in this example is a basic L2CAP header 502 including at least a length and a channel ID. Information included in the header may then be used in routing the packet to the next layer.

The process of header creation repeats in the next layer, and this information is inserted in front of the packet (as received) before being forwarded to the next layer. As a result, for each subsequent layer 504 to 508 through which the original packet passes, the packet will expand in size. The packet may grow so large that, in the case of some networks, the packet will exceed the maximum allowed length and will have to be split. This is shown in FIG. 5A at 510 and 512. These two packets may be transmitted separately via wireless communication and then reassembled by a receiving device. In the receiving device the process may work in reverse, wherein each level from PHY to L2CAP (in the case of Bluetooth™) removes the packet information originally added by the corresponding layer in the sending device until the original packet manifests at the top level.

In many wireless systems this packet size enlargement may not be a problem. Systems with more processing resources and unlimited power may be designed to handle higher packet traffic with larger packets. However, moving large packets may present a problem in restricted resource systems. Each transferred byte takes additional power, so systems that run under tight power constraints, for example battery-powered systems in small electronic devices, may experience operational difficulties due to the energy wasted in moving large packets.

### VI. Packet ID

The present invention, in at least one embodiment, seeks to avoid the packet enlargement problem for low power wireless communication mediums. This is done by replacing a system where header information is constantly added to each packet with an Identification (ID) that precisely defines where each packet should be routed. An example of the present invention is shown in FIG. 5B. Large packet 520 is the result of the known process as described above. This packet has multiple header portions inserted in front of the original payload section, and as a result has expanded as previously described. However, through the use of mapping tables 522 and 524, the same payload information contained in packet 520 may now be included in a much smaller packet 526. The “ID” and “Length” section of packet 526 may only be 1 byte long, and the data section may be anywhere from 0-255 bytes. Since the over all size of the packet is fixed, it takes less power to transmit, receive and process packet 526 as compared to packet 520.

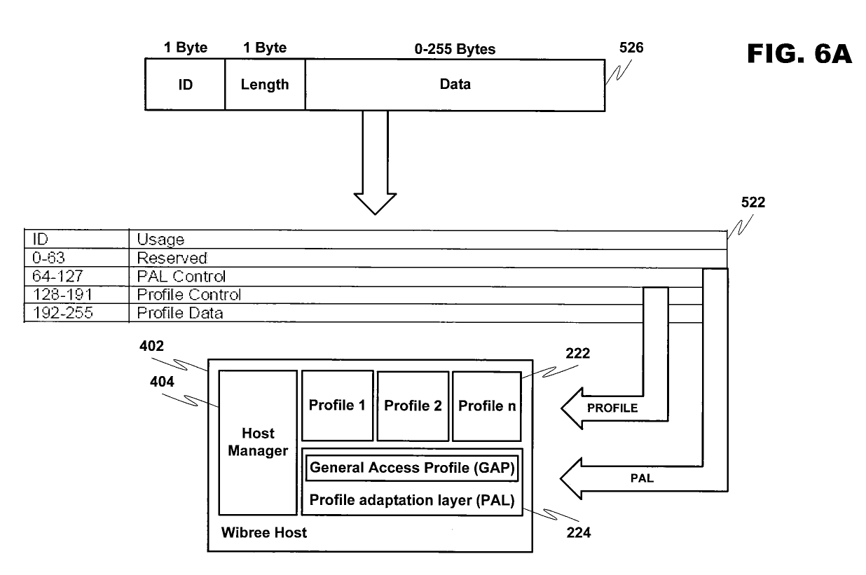

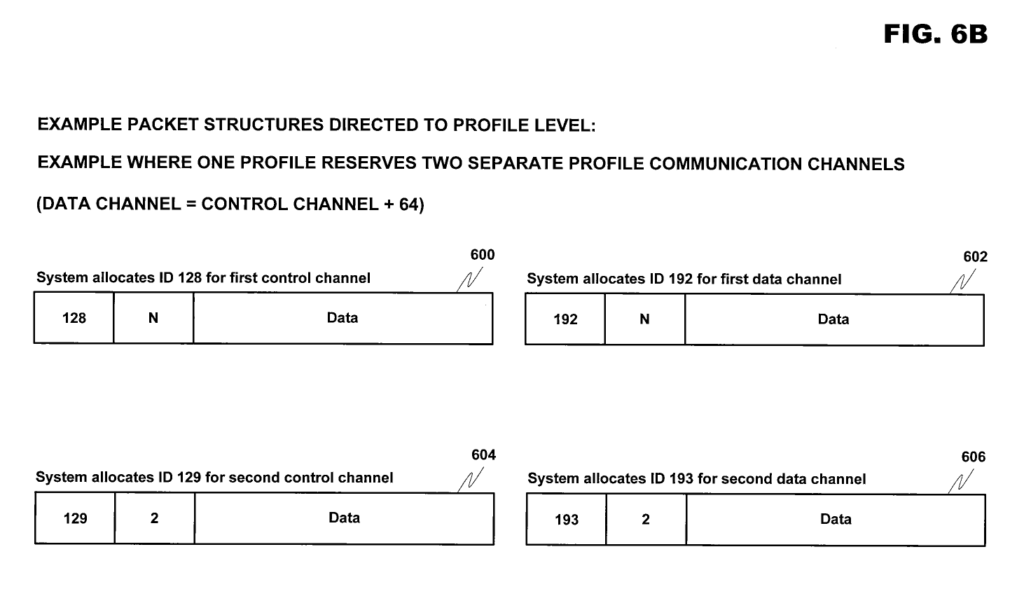

FIG. 6A discloses how packet 526 may, in accordance with at least one embodiment of the present invention, be routed. Mapping table 522 may include ranges of ID numbers from 0-255 according to at least one embodiment of the present invention. These ranges may dictate where a packet is supposed to be routed. For example, the range 64-127 in mapping table 522 is reserved for PAL control messages. This means that any message within that range should be routed to PAL 224. Further, the range 128-191 is reserved for profile control information, and the range 192-255 is reserved for profile data. Any information in these ranges will be routed to the W Profiles layer 222. This is further shown by the arrows indicating where packets should be routed in Wibree™ host section 402.

Specific examples of how routing may occur are now disclosed in FIG. 6B. These examples show exemplary packets that would be routed to the profile layer of Wibree™ protocol stack 220. Example packet 600 shows a Wibree™ communication system allocating ID “128” for a first control channel. The ID “128” falls within the range of information that would be routed to W Profiles layer 122. As set further set forth in FIG. 4B, a data channel will be the “control channel+64.” Therefore, the system allocates ID “192” for the first data channel in example packet 602. “192” falls within the range of IDs reserved for profile data, which may result in this information also being routed to W Profiles layer 222. Likewise, in example packet 604 the second control channel is set to “129,” and as a result, the corresponding data channel is set to “193” in packet 606.

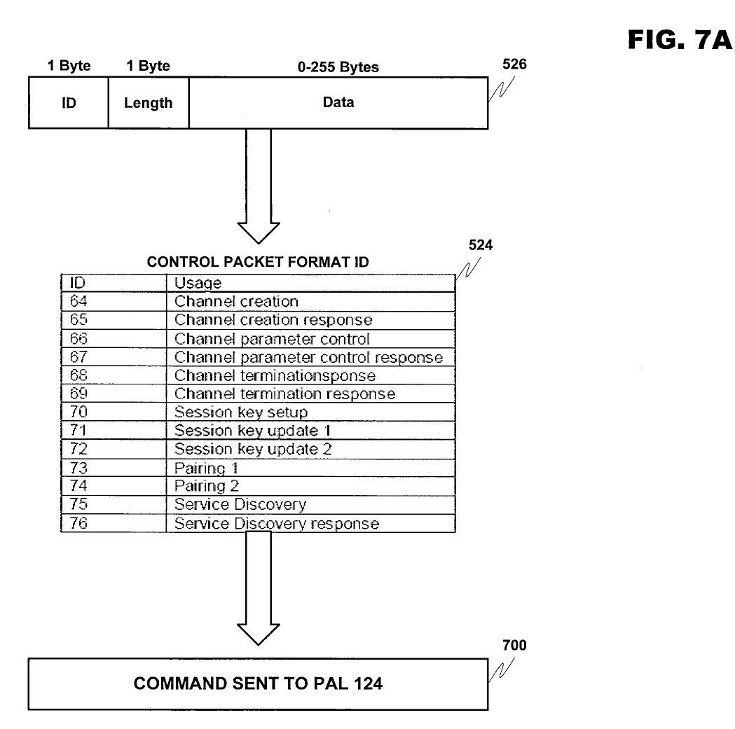

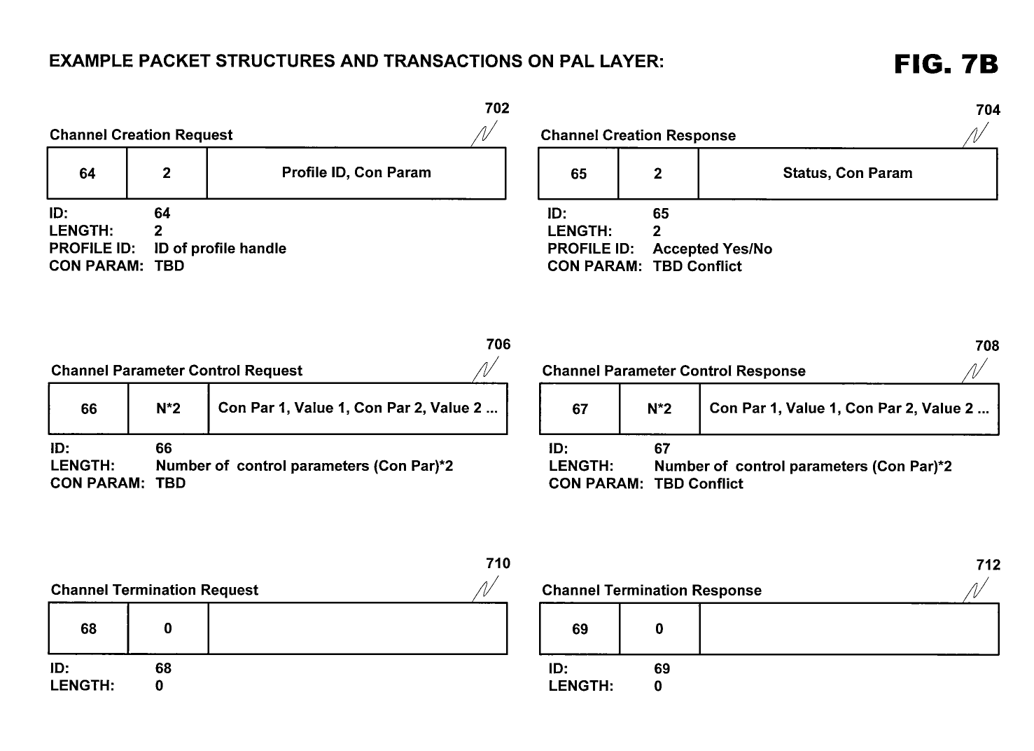

FIG. 7A discloses a further example of ID mapping in accordance with at least one embodiment of the present invention. Again, packet 526 may be routed according to the range in which the ID falls. If the ID falls in the range 64-127, then the packet is a command packet intended for PAL 224. FIG. 7A includes an exemplary mapping table 524, which maps ID numbers specifically in the 64-127 range to commands that may be used in Wibree™ communication transactions according to at least one embodiment of the present invention. These commands may then be sent to the PAL 224 (shown at 700).

Exemplary packets in accordance with the description in FIG. 7A are now disclosed in FIG. 7B. All of the packets 702-712 may be routed to PAL 224 because they fall in the ID range 64-127. In example packet 702, a channel creation request is shown. The ID “64” identifies the packet as a channel creation request packet (per mapping table 524). The length of the packet is 2, which includes a Profile ID and a Con parameter in the payload section. A similar packet for acknowledging the channel creation request is shown at packet 704. Here, the ID is “65,” and the length is 2 including a response parameter of Status and a Con parameter. The status response may acknowledge yes or no as to whether the channel creation request was accepted.

Packets 706 and 708 are examples of variable length packets. The length of these packets depends on the number of control parameters multiplied by 2. This is because there is an identification (Con Par) for each control parameter value (Value). The ID “66” indicates that the packet is a channel parameter control request, to which a response is identified by ID “67.” A further example is show of a channel termination request and a response in packets 710 and 712 respectively. Here, both the request and response do not require parameters (since a termination of a connection is being requested), and therefore the length of a message with ID “68” or “69” is “0.”

### VII. Process Flow

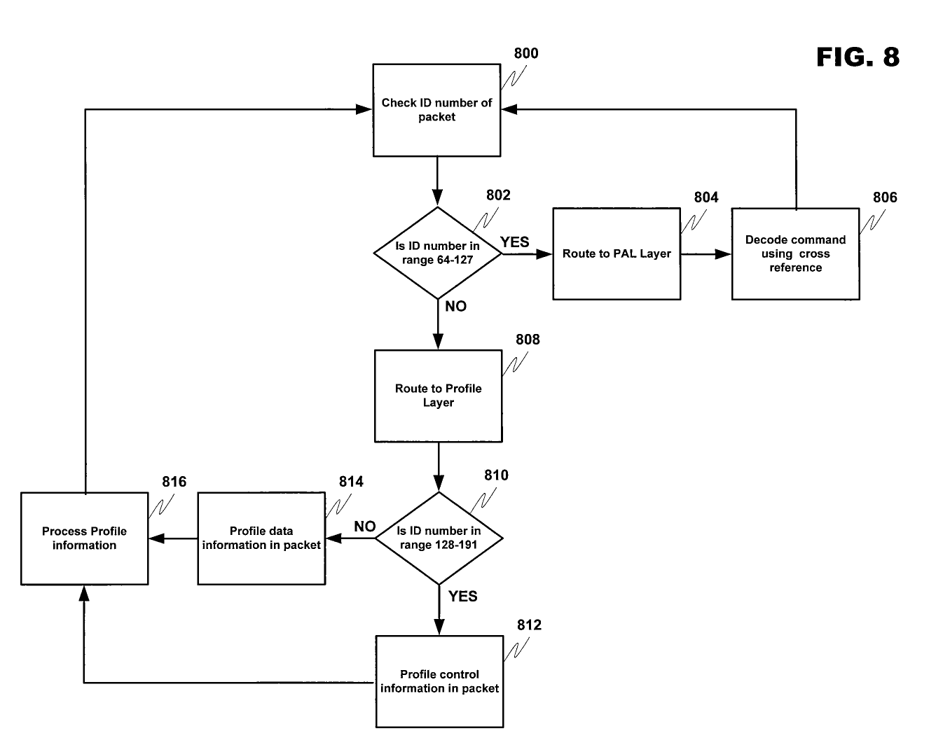

A process flow in accordance with at least one embodiment of the present invention is disclosed in FIG. 8. In step 800, the ID number of a packet is checked to determine in what range the ID number falls. This check may occur, for example, using previously discussed mapping table 522. If the ID number is in the range 64-127 in step 802, then the packet should be forwarded to the PAL 224 in step 804 and further decoded to determine the command being issued in step 806. The decoding of the command being issued may occur using mapping table 524. After the ID is decoded and/or processed, and the packet is forwarded, the process may restart again at step 800. Alternatively, if the ID number does not fall in the range 64-127, then the packet should be routed to W Profile layer 222 in step 808. If the ID number is in the range 128-191, then per step 810 the information contained the packet is profile control information (step 812). If the information is not in the range 128-191, the packet contains profile data information per step 814. In either case, the profile data may be processed (e.g., forwarded to the appropriate destination) in step 816 according to the type of data and the contents of the payload section, and then the process may resume at step 800.

The present invention is an improvement over existing systems in at least one benefit that may be realized in the expedited identification and routing of packets without the additional detriment often found in traditional system where the packet grows in size as it traverses from one layer to another. In at least one embodiment of the present invention, a packet may be routed while remaining the same size as when originally created, and as a result, power may be conserved because less information will need to be conveyed in order to achieve the same information transaction. This power savings becomes increasingly important in the resource constrained systems that are currently emerging in the marketplace today.

Accordingly, it will be apparent to persons skilled in the relevant art that various changes in form a and detail can be made therein without departing from the spirit and scope of the invention. This the breadth and scope of the present invention should not be limited by any of the above-described exemplary embodiments, but should be defined only in accordance with the following claims and their equivalents.

What is claimed:

1. A method for processing information, comprising:
maintaining at least one set of virtual packet identification indicators for identifying and routing information to an appropriate communication layer;
receiving information including a virtual packet identification; and
resolving an information type and a communication protocol layer to which the received information should be routed by mapping the virtual packet identification included in the received information with the virtual packet identification indicators.

2. The method of claim 1, wherein the at least one set of virtual packet identifiers includes at least a correspondence between an identification number and a type of data in the payload of the packet.

3. The method of claim 1, wherein the set of virtual packet identifiers includes at least a correspondence between a virtual packet identifier and a destination layer of a communication protocol stack to which the received information should be routed.

4. The method of claim 1, wherein the communication protocol layer is a layer of a communication protocol stack for a wireless communication protocol.

5. The method of claim 1, wherein the information is received via wireless transmission.

6. The method of claim 1, wherein resolving an information type includes determining whether the information is at least one of a control type and a data type.

7. The method of claim 6, wherein the control type correspond to commands for controlling a communication session in a wireless communication protocol.

8. The method of claim 6, wherein the data type corresponds to information regarding an application or peripheral device enabled to communicate using a wireless communication protocol.

9. The method of claim 1, wherein resolving a communication protocol layer to which the received data should be routed includes determining whether the information should be routed to at least one of a W Profile layer and a profile adaptation layer (PAL).

10. The method of claim 1, wherein mapping the virtual packet identification includes comparing at least the virtual packet identification to a range of identification numbers to determine if the virtual packet identification is within the range of identification numbers.

11. A computer program product comprising a computer usable medium having computer readable program code embodied in said medium for processing information, comprising:
a computer readable program code for maintaining at least one set of virtual packet identification indicators for identifying and routing information to an appropriate communication layer;
a computer readable program code for receiving information including a virtual packet identification; and
a computer readable program code for resolving an information type and a communication protocol layer to which the received information should be routed by mapping the virtual packet identification included in the received information with the virtual packet identification indicators.

12. The computer program product of claim 11, wherein the at least one set of virtual packet identifiers includes at least a correspondence between an identification number and a type of data in the payload of the packet.

13. The computer program product of claim 11, wherein the set of virtual packet identifiers includes at least a correspondence between a virtual packet identifier and a destination layer of a communication protocol stack to which the received information should be routed.

14. The computer program product of claim 11, wherein the communication protocol layer is a layer of a communication protocol stack for a wireless communication protocol.

15. The computer program product of claim 11, wherein the information is received via wireless transmission.

16. The computer program product of claim 11, wherein resolving an information type includes determining whether the information is at least one of a control type and a data type.

17. The computer program product of claim 16, wherein the control type correspond to commands for controlling a communication session in a wireless communication protocol.

18. The computer program product of claim 16, wherein the data type corresponds to information regarding an application or peripheral device enabled to communicate using a wireless communication protocol.

19. The computer program product of claim 11, wherein resolving a communication protocol layer to which the received data should be routed includes determining whether the information should be routed to at least one of a W Profile layer and a profile adaptation layer (PAL).

20. The computer program product of claim 11, wherein mapping the virtual packet identification includes comparing at least the virtual packet identification to a range of identification numbers to determine if the virtual packet identification is within the range of identification numbers.

21. A device, comprising:
At a least a processor for executing method steps including:
maintaining at least one set of virtual packet identification indicators for identifying and routing information to an appropriate communication layer;
receiving information including a virtual packet identification; and
resolving an information type and a communication protocol layer to which the received information should be routed by mapping the virtual packet identification included in the received information with the virtual packet identification indicators.

22. The device of claim 21, wherein the device is a wireless communication device.

23. The device of claim 21, wherein the device further comprises a transmitter and receiver for communicating via a wireless communication protocol.

24. The device of claim 23, wherein the received information is received via the wireless communication protocol.

25. The device of claim 23, wherein the device is enabled to communicate using the Wibree™ wireless communication protocol.

26. The device of claim 24, wherein received information is received via Wibree™ communication.

27. A data structure, comprising:
a communication packet, the packet further including at least a header section and a payload section;
the header section further comprising ID information and length information;
wherein the ID information is usable to resolve an information type and a communication protocol layer to which the packet should be routed by mapping the ID information with a virtual packet identification indicator.

28. The data structure of claim 27, wherein the ID information is a number in the range 0-255.
